(19) United States
(12) Patent Application Publication
(10) Pub. No.: US 2026/0100408 A1
(43) Pub. Date: Apr. 9, 2026

(54) SOLID ELECTROLYTE MATERIAL AND BATTERY

(71) Applicant: TOYOTA JIDOSHA KABUSHIKI KAISHA, Toyota-shi (JP)

(72) Inventors: Kazuya TAKEUCHI, Shizuoka-ken (JP); Hirofumi NAKAMOTO, Shizuoka-ken (JP); Makoto KIYOCHI, Susono-shi (JP)

(73) Assignee: TOYOTA JIDOSHA KABUSHIKI KAISHA, Toyota-shi (JP)

(21) Appl. No.: 19/247,029

(22) Filed: Jun. 24, 2025

(30) Foreign Application Priority Data
Oct. 3, 2024 (JP) 2024-174041

(51) Int. Cl. H01M 10/056; H01M 10/0525

(52) U.S. Cl. CPC H01M 10/056; H01M 10/0525; H01M 2300/0065

(57) ABSTRACT

The present disclosure relates to a solid electrolyte material. The solid electrolyte material contains a sulfide solid electrolyte containing a lithium element, a sulfur element, and a phosphorus element, and an organic compound. The organic compound has two or more benzene rings, and a melting point of the organic compound is 82° C. or lower.

### CROSS-REFERENCE TO RELATED APPLICATION

This application claims priority to Japanese Patent Application No. 2024-174041 filed on Oct. 3, 2024. The disclosure of the above-identified application, including the specification, drawings, and claims, is incorporated by reference herein in its entirety.

### BACKGROUND

### 1. Technical Field

The present disclosure relates to a solid electrolyte material and a battery.

### 2. Description of Related Art

Various technologies have been proposed regarding solid electrolytes like the one disclosed in Japanese Unexamined Patent Application Publication No. 2024-093769 (JP 2024-093769 A).

### SUMMARY

When a filling factor of a solid electrolyte material including a sulfide solid electrolyte and an organic compound is low, this leads to a problem that the resistance of an electrode layer including this solid electrolyte material becomes high.

The present disclosure has been made in view of the above situation, and a main object thereof is to provide a solid electrolyte material of which a decrease in filling factor can be avoided.

Specifically, the present disclosure includes the following aspects:

<1> A solid electrolyte material that contains a sulfide solid electrolyte containing a lithium element, a sulfur element, and a phosphorus element, and an organic compound, wherein:
the organic compound has two or more benzene rings; and
a melting point of the organic compound is 82° C. or lower.

<2> The solid electrolyte material according to <1>, wherein the melting point of the organic compound may be 37° C. or lower.

<3> The solid electrolyte material according to <1> or <2>, wherein the organic compound may have two benzene rings.

<4> The solid electrolyte material according to <1>, wherein the organic compound may be at least one type selected from a group consisting of naphthalene, 1-methylnaphthalene, 2-methylnaphthalene, 1,4-dimethylnaphthalene, 1,5-dimethylnaphthalene, and biphenyl.

<5> A battery having a positive electrode layer, a negative electrode layer, and an electrolyte layer, wherein:
the battery includes, in the positive electrode layer or the negative electrode layer, an electrode composite material including the solid electrolyte material according to any one of <1> to <4> and an electrode active material; and
at least part of the organic compound is present between the electrode active material and the sulfide solid electrolyte.

The present disclosure offers the advantage of being able to obtain a solid electrolyte material of which a decrease in filling factor can be avoided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating a battery in the present disclosure;

FIG. 2 is a graph showing a relationship between a melting point of an organic compound and a filling factor, of each of solid electrolyte materials respectively obtained in Examples 1 to 9 and Comparative Examples 1 to 6; and

FIG. 3 is a graph showing a relationship between a melting point of an organic compound and a filling factor, of each of electrode layers respectively obtained in Examples 10 to 12 and Comparative Examples 7 to 9.

### DETAILED DESCRIPTION OF EMBODIMENTS

Unless otherwise noted, an average particle diameter of particles in the present disclosure is a value of a median diameter (D50) that is a particle diameter at an integrated value of 50% in a volume-based particle size distribution that is measured by laser diffraction-scattering particle diameter distribution measurement.

### A. Solid Electrolyte Material

The present disclosure provides a solid electrolyte material that contains a sulfide solid electrolyte containing a lithium element, a sulfur element, and a phosphorus element, and an organic compound, wherein:
the organic compound has two or more benzene rings; and
a melting point of the organic compound is 82° C. or lower.

The solid electrolyte material contains the sulfide solid electrolyte and the organic compound.

The organic compound is a compound having two or more benzene rings.

When the solid electrolyte material does not include the organic compound, particles of the sulfide solid electrolyte do not easily slide over one another, resulting in a lower filling factor of the solid electrolyte material. Including the organic compound allows the particles of the sulfide solid electrolyte to easily slide over one another, thereby improving the filling factor of the solid electrolyte material.

The organic compound used in the present disclosure is basically non-polar, hydrophobic molecules and easily adsorbs to a highly hydrophobic substance. The sulfide solid electrolyte used in the present disclosure is a substance with low polarity and therefore has good compatibility with the organic compound.

As the organic compound improves the filling factor of the solid electrolyte material, it can be expected to have an effect of inhibiting an increase in resistance by reducing voids in an electrode layer that uses this solid electrolyte material.

The melting point of the organic compound should be 82° C. or lower and may be 37° C. or lower.

In the organic compound used in the present disclosure, a plurality of molecules of the organic compound is stacked through an intermolecular force between aromatic π-bonds. When the solid electrolyte material is pressed, a plurality of particles of the sulfide solid electrolyte slides over one another like layer displacement through the organic compound present between these particles. Thus, the organic compound functions as a lubricant that lubricates the particles of the sulfide solid electrolyte. Therefore, an organic compound with a high stacking force derived from the intermolecular force between the aromatic π-bonds, i.e., with a high melting point (exceeding 82° C.) is less likely to cause layer displacement and thus cannot be expected to have an excellent lubricating effect. On the other hand, an organic compound with a low stacking force derived from the intermolecular force between the aromatic π-bonds, i.e., with a low melting point (82° C. or lower) allows layer displacement to occur easily during pressing of the solid electrolyte material, and thus exhibits an excellent lubricating function and improves the filling factor of the solid electrolyte material.

The number of the benzene rings included in the organic compound should be two or more, and may be three or less or may be two. For the organic compound to exhibit the lubricating effect, its molecules need to stack through the intermolecular force between the aromatic π-bonds. It is presumed that when the number of the benzene rings is two or more, compared with when it is one, the molecules are flatter and therefore easily stackable, which helps exhibit the lubricating effect. It is presumed that when the number of the benzene rings is three or less, the stacking force of the aromatic π-bonds does not become too high and the particles easily slide over one another.

Examples of organic compounds include condensed polycyclic hydrocarbons, such as naphthalene, derivatives of condensed polycyclic hydrocarbons, biphenyl and derivatives thereof, and compounds in which a plurality of benzene rings is connected to one another by an organic group.

The organic compound may be at least one type selected from a group consisting of naphthalene (melting point 80.2° C.), 1-methylnaphthalene (melting point −22° C.), 2-methylnaphthalene (melting point 37° C.), 1,2-dimethylnaphthalene (melting point 1.6° C.), 1,3-dimethylnaphthalene (melting point −6° C.), 1,4-dimethylnaphthalene (melting point 7.6° C.), 1,5-dimethylnaphthalene (melting point 82° C.), 1,6-dimethylnaphthalene (melting point −13.9° C.), 1,7-dimethylnaphthalene (melting point −6° C.), 1-fluoronaphthalene (melting point −9° C.), 1-chloronaphthalene (melting point −2.5° C.), 1-bromonaphthalene (melting point −1.8° C.), 1-iodonaphthalene (melting point 4.2° C.), and biphenyl (melting point 69° C.).

The ratio of the organic compound to 100 mass % of the solid electrolyte material should exceed 0 mass %, and may be 1 mass % or higher, or 5 mass % or lower, or 2 mass % or lower.

Whether the above-described organic compound is included in the solid electrolyte material can be confirmed by performing Raman analysis on the solid electrolyte material.

The sulfide solid electrolyte contains a lithium element, a sulfur element, and a phosphorus element. The sulfide solid electrolyte may further contain an Me element (at least one type among As, Sb, Si, Ge, Sn, Bi, Al, Zn, Ga, and In). The sulfide solid electrolyte may contain a halogen element, such as F, Cl, Br, or I.

The sulfide solid electrolyte may be a glass-based (amorphous) sulfide solid electrolyte, or may be a glass ceramic-based sulfide solid electrolyte, or may be a crystalline sulfide solid electrolyte. The sulfide solid electrolyte may have a crystal phase. Examples of the crystal phase include a Thio-LISICON-type crystal phase, an argyrodite-type crystal phase, and an LGPS-type crystal phase.

While the composition of the sulfide solid electrolyte is not particularly limited, examples include xLi₂S·(1-x)P₂S₅ (0.5≤x<1) and yLiI·zLiBr·(100-y-z)(xLi₂S·(1-x)P₂S₅) (0.5≤x<1, 0≤y≤30, 0≤z≤30). In these compositions, x may meet 0.7≤x≤0.8. Another example of the composition of the sulfide solid electrolyte is Li₇₋ₓPS₆₋ₓXₓ. X is at least one type among F, Cl, Br, and I, and x meets 0≤x<2. Yet another example of the composition of the sulfide solid electrolyte is Li₄₋ₓMe₁₋ₓPₓS₄ (0<x<1). The Me element is as defined above. Examples of sulfide solid electrolytes include Li₃PS₄—LiI—LiBr, LiI—LiBr—Li₂S—P₂S₅, LiI—Li₂S—P₂S₅, LiI—Li₂S—P₂O₅, and LiI—Li₃PO₄—P₂S₅.

The shape of the sulfide solid electrolyte may be a particulate shape from the viewpoint of good handleability.

The average particle diameter (D50) of the particles of the sulfide solid electrolyte is not particularly limited and may be 1 nm to 100 μm.

The ratio of the sulfide solid electrolyte to 100 mass % of the solid electrolyte material may be 95 mass % or higher or 98 mass % or higher, and the upper limit may be lower than 100 mass % or 99 mass % or lower.

### B. Battery

The present disclosure provides a battery having a positive electrode layer, a negative electrode layer, and an electrolyte layer, wherein:
the battery includes, in the positive electrode layer or the negative electrode layer, an electrode composite material including the above-described solid electrolyte material and an electrode active material, the solid electrolyte material containing the above-described sulfide solid electrolyte containing a lithium element, a sulfur element, and a phosphorus element and the above-described organic compound; and
at least part of the organic compound is present between the electrode active material and the sulfide solid electrolyte.

The electrode composite material includes the solid electrolyte material and the electrode active material.

At least part of the organic compound in the electrode composite material is present between the electrode active material and the sulfide solid electrolyte. Thus, it is conjectured that the organic compound functions as a barrier and inhibits a side reaction of the sulfide solid electrolyte (improves the reduction resistance). Here, a benzene ring has a conjugated structure with double bonds and single bonds alternately succeeding each other, and has a π-electron cloud. Therefore, it is conjectured that in an organic compound having two or more benzene rings, a region where the π-electron cloud spreads is large, which allows for favorable chemical stability (oxidation resistance, reduction resistance), and that, as a result, the chemical stability improves also in the sulfide solid electrolyte located near such an organic compound. It is conjectured that this mechanism inhibits an increase in resistance in a battery that uses the electrode composite material in the present disclosure.

When the electrode composite material is included in the positive electrode layer, the electrode composite material is a positive electrode composite material, and the positive electrode composite material includes the above-described solid electrolyte material and a positive electrode active material.

When the electrode composite material is included in the negative electrode layer, the electrode composite material is a negative electrode composite material, and the negative electrode composite material includes the above-described solid electrolyte material and a negative electrode active material.

When the battery of the present disclosure includes the positive electrode composite material in the positive electrode layer, it may, but need not, include the above-described solid electrolyte material in the negative electrode layer.

When the battery of the present disclosure includes the negative electrode composite material in the negative electrode layer, it may, but need not, include the above-described solid electrolyte material in the positive electrode layer.

The battery of the present disclosure may include the positive electrode composite material in the positive electrode layer as well as include the negative electrode composite material in the negative electrode layer.

The battery in the present disclosure has the positive electrode layer, the negative electrode layer, and the electrolyte layer, and normally has a positive electrode including the positive electrode layer and a negative electrode including the negative electrode layer.

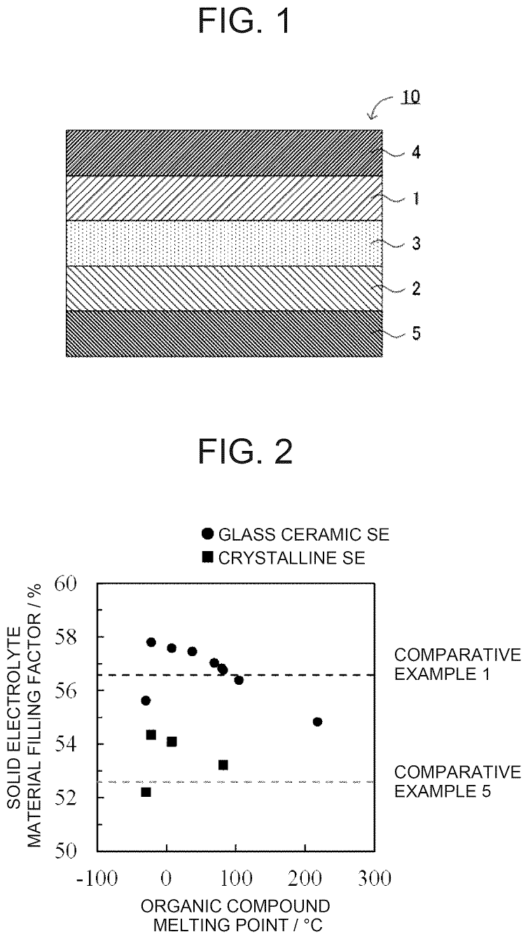

FIG. 1 is a schematic sectional view illustrating the battery in the present disclosure. A battery 10 shown in FIG. 1 has a positive electrode layer 1, a negative electrode layer 2, an electrolyte layer 3 disposed between the positive electrode layer 1 and the negative electrode layer 2, a positive electrode current collector 4 that collects a current of the positive electrode layer 1, and a negative electrode current collector 5 that collects a current of the negative electrode layer 2. In the present disclosure, at least either the positive electrode layer 1 or the negative electrode layer 2 includes the solid electrolyte material described above in “A. Solid Electrolyte Material.”

According to the present disclosure, by using the above-described solid electrolyte material, the battery has a high filling factor of the electrode layer and low resistance.

### Positive Electrode

The positive electrode has a positive electrode layer, and further has a positive electrode current collector as necessary.

The positive electrode layer is a layer including at least a positive electrode active material. The positive electrode layer may be a layer containing a positive electrode composite material that includes the above-described solid electrolyte material and a positive electrode active material. The positive electrode layer may contain at least one of a solid electrolyte, a conductive material, and a binder as necessary.

Examples of positive electrode active materials include oxide active materials. Examples of oxide active materials include bedded salt-type active materials, such as LiCoO₂, LiMnO₂, LiNiO₂, LiVO₂, and LiNi_{1/3}Co_{1/3}Mn_{1/3}O₂, spinel-type active materials, such as LiMn₂O₄, Li₄Ti₅O₁₂, and Li(Ni_{0.5}Mn_{1.5})O₄, and olivine-type active materials, such as LiFePO₄, LiMnPO₄, LiNiPO₄, and LiCoPO₄.

On a surface of the positive electrode active material, a coating layer containing an Li ion-conducting compound may be formed. This is because then a reaction between the positive electrode active material and the solid electrolyte can be inhibited. Examples of Li ion-conducting compounds include B₂O₃, Li₂B₄O₇, LiBPO₄, Li₃PO₄, LiPO₃, and LiNbO₃. The thickness of the coating layer is, for example, 1 nm or larger and 30 nm or smaller. The coverage of the Li ion-conducting compound coating the positive electrode active material is, for example, 70% or higher, and may be 90% or higher or may be 100%. The coating method of the Li ion-conducting compound is not particularly limited, and a conventionally commonly known method can be adopted as appropriate.

The shape of the positive electrode active material is normally a particulate shape. The positive electrode active material may be primary particles or may be secondary particles into which primary particles have aggregated.

While the mean particle diameter (D50) of the positive electrode active material is not particularly limited, it is, for example, 0.01 μm or larger and 50 μm or smaller, and may be 0.5 μm or larger and 30 μm or smaller.

The ratio of the positive electrode active material in the positive electrode layer may be, for example, 20 mass % or higher. If the ratio of the positive electrode active material is too low, sufficient energy density may fail to be obtained. On the other hand, the ratio of the positive electrode active material in the positive electrode layer may be, for example, 80 mass % or lower. If the ratio of the positive electrode active material is too high, the ion conductivity and the electron conductivity in the positive electrode layer may relatively decrease.

The ratio of the sulfide solid electrolyte in the positive electrode layer may be, for example, 10 mass % or higher. If the ratio of the sulfide solid electrolyte is too low, an ion conducting path in the positive electrode layer may become insufficient. On the other hand, the ratio of the sulfide solid electrolyte in the positive electrode layer may be, for example, 60 mass % or lower. If the ratio of the sulfide solid electrolyte is too high, the ratio of the positive electrode active material becomes relatively lower, which may lead to lower energy density.

The positive electrode layer may contain a conductive material. Adding a conductive material improves the electron conductivity of the positive electrode layer. Examples of conductive materials include carbon materials, metal particles, and conductive polymers. Examples of carbon materials include particulate carbon materials, such as acetylene black (AB) and Ketjenblack (KB), and fibrous carbon materials, such as vapor-grown carbon fiber (VGCF), carbon nanotube (CNT), and carbon nanofiber (CNF).

The ratio of the conductive material in the positive electrode layer may be, for example, 0.1 mass % or higher. If the ratio of the conductive material is too low, the electron conducting path in the positive electrode layer may become insufficient. On the other hand, the ratio of the conductive material in the positive electrode layer may be, for example, 5 mass % or lower. If the ratio of the conductive material is too high, the ratio of the positive electrode active material becomes relatively lower, which may lead to lower energy density.

The positive electrode layer may contain a binder. Examples of binders include styrene-butadiene rubber (SBR), acrylonitrile-butadiene rubber (NBR), butadiene rubber (BR), polyvinylidene fluoride (PVDF), polytetrafluoroethylene (PTFE), styrene-isoprene-styrene block copolymer (SIS), and ethylene-propylene-diene copolymer (EPDM).

The ratio of the binder in the positive electrode layer may be, for example, 0.5 mass % or higher. If the ratio of the binder is too low, an increase in resistance due to charge and discharge may fail to be sufficiently reduced. On the other hand, the ratio of the binder in the positive electrode layer may be, for example, 5 mass % or lower. If the ratio of the binder is too high, the ratio of the positive electrode active material becomes relatively lower, which may lead to lower energy density.

The thickness of the positive electrode layer may be, for example, 0.1 μm or larger and 1000 μm or smaller.

While the manufacturing method of the positive electrode layer is not particularly limited, one example is a method in which the above-described positive electrode composite material and a solvent are mixed together to obtain a positive electrode slurry, and this positive electrode slurry is applied to a positive electrode current collector and dried to form a positive electrode layer. When forming the positive electrode layer, a pressing process of pressing the positive electrode layer in a thickness direction may be performed. Examples of pressing processes include roller pressing and flat-plate pressing.

Examples of solvents include tetralin, di-isobutyl ketone, butyl butyrate, mesitylene, heptane, dibutyl ether, decane, dodecane, isodecane, and toluene, and the solvent may include two or more components among these.

Examples of the material of the positive electrode current collector include SUS, Cr, Au, Pt, Zn, aluminum, copper, nickel, iron, titanium, and carbon. The thickness of the positive electrode current collector is, for example, 0.1 μm or larger and 100 μm or smaller. The shape of the positive electrode current collector may be a foil shape, a plate shape, etc. While the shape of the positive electrode current collector as seen in a plan view is not particularly limited, examples include a circular shape, an elliptic shape, a rectangular shape, and an arbitrary polygonal shape. The positive electrode current collector may have a configuration in which a buffer layer, an elastic layer, or a positive temperature coefficient (PTC) thermistor layer is disposed on a surface.

### Negative Electrode

The negative electrode has a negative electrode layer, and further has a negative electrode current collector as necessary.

The negative electrode layer is a layer containing at least a negative electrode active material. The negative electrode layer may be a layer containing a negative electrode composite material that includes the above-described solid electrolyte material and a negative electrode active material. The negative electrode layer may contain at least one of a solid electrolyte, a conductive material, and a binder as necessary.

Examples of negative electrode active materials include Si-based active materials, carbon-based active materials, oxide-based active materials, and Li-based active materials.

Examples of Si-based active materials include Si as a single element, Si alloys, Si oxides, and Si carbides. Examples of metals other than Si in Si alloys include Li, Sn, Fe, Co, Ni, Ti, Cr, Na, W, Mo, V, Nb, Zr, and Hf. Si alloys may contain only one type, or two or more types, of metal other than Si. One example of Si oxides is SiO. One example of Si carbides is SiC.

Examples of carbon-based active materials include graphite, hard carbon, and soft carbon.

One example of oxide-based active materials is lithium titanate.

Examples of Li-based active materials include Li as a single element and Li alloys. Examples of metal elements other than lithium included in Li alloys include Mg, Ag, In, Sn, Si, Ga, Au, and Pt.

As for the conductive material and the binder used for the negative electrode layer, the same ones that have been described above for the positive electrode layer can be named as examples.

Examples of the material of the negative electrode current collector include SUS, aluminum, copper, nickel, iron, titanium, and carbon. While the thickness of the negative electrode current collector varies with the shape, it may be, for example, within a range of 1 μm to 50 μm. The shape of the negative electrode current collector may be a foil shape, a plate shape, etc. While the shape of the negative electrode current collector as seen in a plan view is not particularly limited, examples include a circular shape, an elliptic shape, a rectangular shape, and an arbitrary polygonal shape. The negative electrode current collector may have a configuration in which a buffer layer, an elastic layer, or a PTC thermistor layer is disposed on a surface.

### Electrolyte Layer

The electrolyte layer is a layer that is formed between the positive electrode layer and the negative electrode layer and contains at least an electrolyte. The electrolyte may be a solid electrolyte (which may be referred to as “SE”) or may be a liquid electrolyte (electrolytic solution).

As the electrolytic solution, a non-aqueous electrolytic solution etc. can be used. Only one type of non-aqueous electrolytic solution may be used alone, or two or more types thereof may be used in combination.

As the non-aqueous electrolytic solution, normally one containing a lithium salt and a non-aqueous solvent is used. Examples of lithium salts include inorganic lithium salts, such as LiPF₆, LiBF₄, LiClO₄, and LiAsF₆, and organic lithium salts, such as LiCF₃SO₃, LiN(SO₂CF₃)₂(Li-TFSI), LiN(SO₂C₂F₅)₂, and LiC(SO₂CF₃)₃.

Examples of non-aqueous solvents include ethylene carbonate (EC), propylene carbonate (PC), butylene carbonate (BC), dimethyl carbonate (DMC), diethyl carbonate (DEC), ethyl methyl carbonate (EMC), γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyltetrahydrofuran, dimethyl sulfoxide (DMSO), and mixtures of these.

The concentration of the lithium salt in the non-aqueous electrolytic solution may be, for example, 0.3 to 5 M.

As the electrolyte layer, a separator may be used that is impregnated with an electrolyte, such as the above-described electrolytic solution, and that prevents contact between the positive electrode layer and the negative electrode layer.

The material of the separator is not particularly limited as long as it is a porous film. Examples include resins, such as polyethylene (PE), polypropylene (PP), polyester, polyvinyl alcohol, cellulose, and polyamide, and particularly polyethylene or polypropylene may be adopted. The above-described separator may have a single-layer structure or may have a multi-layer structure. Examples of separators with a multi-layer structure include a separator with a PE-PP double-layer structure, and a separator with a PP-PE-PP or PE-PP-PE three-layer structure.

The separator may be a non-woven fabric, such as a resin non-woven fabric or a glass fiber non-woven fabric.

The electrolyte layer may be a solid electrolyte layer composed of a solid.

The solid electrolyte layer includes a solid electrolyte, and includes a binder etc. as necessary.

The solid electrolyte layer includes, as the solid electrolyte, the sulfide solid electrolyte described above in “A. Solid Electrolyte Material.”

One type of solid electrolyte may be used alone, or two or more types thereof may be used. When using two or more types of solid electrolytes, the two or more types of solid electrolytes may be mixed together, or two or more layers of the respective solid electrolytes may be formed to constitute a multi-layer structure.

While the ratio of the solid electrolyte in the solid electrolyte layer is not particularly limited, it may be, for example, 50 mass % or higher and may be 100 mass %. The solid electrolyte layer may include less than 10 mass % an electrolytic solution relative to the total amount of the solid electrolyte layer.

As the binder, a binder that can be contained in the above-described positive electrode layer can be given as an example.

The content of the binder in the solid electrolyte layer may be 0 mass % to 10 mass % relative to the total amount of the solid electrolyte layer.

The thickness of the electrolyte layer may be, for example, 0.1 μm or larger and 1000 μm or smaller.

The battery in the present disclosure may further have a restraining jig that applies a restraining pressure to the positive electrode layer, the electrolyte layer, and the negative electrode layer along the thickness direction. In particular, when the electrolyte layer is a solid electrolyte layer, a restraining pressure may be applied to form favorable ion conducting path and electron conducting path. The restraining pressure may be, for example, 0.1 MPa or higher. On the other hand, the restraining pressure may be, for example, 100 MPa or lower.

### Battery

While the type of the battery in the present disclosure is not particularly limited, it is typically a lithium-ion battery. The battery in the present disclosure may be a liquid battery in which the electrolyte layer contains an electrolytic solution, or may be a solid-state battery in which the electrolyte layer contains a solid electrolyte. The solid-state battery may be a semi-solid-state battery or may be an all-solid-state battery. In the present disclosure, a semi-solid-state battery is a battery in which the electrolyte layer has a solid electrolyte and liquid components (e.g., a solvent and an electrolytic solution). In the present disclosure, an all-solid-state battery is a battery in which the electrolyte layer has only a solid electrolyte as the electrolyte. The battery in the present disclosure may be a primary battery or a secondary battery, and particularly it may be a secondary battery. This is because a secondary battery is repeatedly chargeable and dischargeable, which makes it useful as an on-vehicle battery, for example.

The shape of the battery is not particularly limited, and may be, for example, a coin shape, a cylindrical shape, a rectangular shape, a sheet shape, a button shape, a flat shape, or a laminate shape.

Examples of applications of the battery include power sources of vehicles, such as a hybrid electric vehicle (HEV), a plug-in hybrid electric vehicle (PHEV), a battery electric vehicle (BEV), a gasoline vehicle, and a diesel vehicle. In particular, the battery may be used as a driving power source of a hybrid electric vehicle (HEV), a plug-in hybrid electric vehicle (PHEV), or a battery electric vehicle (BEV). The battery may be used as a power source of a mobile body other than vehicles (e.g., a train, a ship, or an airplane), or may be used as a power source of an electric product, such as an information processing device.

### Example 1

### Production of Solid Electrolyte Material

3000 mg of mesitylene was fed into a propylene container, and 20 mg of 1,5-dimethylnaphthalene as an organic compound was added thereto and dissolved. 1000 mg of particles of a glass ceramic-based sulfide solid electrolyte was fed into the same container, and the mixture was stirred by an ultrasonic homogenizer to obtain a slurry. This slurry was fed into a petri dish and then heated and dried to remove the mesitylene. Thus, a solid electrolyte material was obtained.

### Example 2

A solid electrolyte material was obtained by the same method as in Example 1 except that the organic compound was changed to naphthalene.

### Example 3

A solid electrolyte material was obtained by the same method as in Example 1 except that the organic compound was changed to biphenyl.

### Example 4

A solid electrolyte material was obtained by the same method as in Example 1 except that the organic compound was changed to 2-methylnaphthalene.

### Example 5

A solid electrolyte material was obtained by the same method as in Example 1 except that the organic compound was changed to 1,4-dimethylnaphthalene.

### Example 6

A solid electrolyte material was obtained by the same method as in Example 1 except that the organic compound was changed to 1-methylnaphthalene.

### Comparative Example 1

3000 mg of mesitylene was fed into a propylene container and 1000 mg of particles of a glass ceramic-based sulfide solid electrolyte was fed into the same container, and the mixture was stirred by an ultrasonic homogenizer to obtain a slurry. This slurry was fed into a petri dish and then heated and dried to remove the mesitylene. Thus, a solid electrolyte material was obtained.

### Comparative Example 2

A solid electrolyte material was obtained by the same method as in Example 1 except that the organic compound was changed to decane.

### Comparative Example 3

A solid electrolyte material was obtained by the same method as in Example 1 except that the organic compound was changed to anthracene.

### Comparative Example 4

A solid electrolyte material was obtained by the same method as in Example 1 except that the organic compound was changed to 2,3-dimethylnaphthalene.

### Example 7

A solid electrolyte material was obtained by the same method as in Example 1 except that the glass ceramic-based sulfide solid electrolyte was changed to a crystalline sulfide solid electrolyte.

### Example 8

A solid electrolyte material was obtained by the same method as in Example 1 except that the glass ceramic-based sulfide solid electrolyte was changed to a crystalline sulfide solid electrolyte and that the organic compound was changed to 1,4-dimethylnaphthalene.

### Example 9

A solid electrolyte material was obtained by the same method as in Example 1 except that the glass ceramic-based sulfide solid electrolyte was changed to a crystalline sulfide solid electrolyte and that the organic compound was changed to 1-methylnaphthalene.

### Comparative Example 5

A solid electrolyte material was obtained by the same method as in Comparative Example 1 except that the glass ceramic-based sulfide solid electrolyte was changed to a crystalline sulfide solid electrolyte.

### Comparative Example 6

A solid electrolyte material was obtained by the same method as in Example 1 except that the glass ceramic-based sulfide solid electrolyte was changed to a crystalline sulfide solid electrolyte and that the organic compound was changed to decane.

### Measurement of Filling Factor of Solid Electrolyte Material

100 mg of each of the solid electrolyte materials respectively obtained in Examples 1 to 9 and Comparative Examples 1 to 6 was fed into a cylinder with a diameter of 11.28 mm. The layer of the solid electrolyte material was held by SUS pins from above and below and subjected to pressing at 19.6 MPa, and the volume of the solid electrolyte material after the pressing was used as the apparent volume of the solid electrolyte material. The ratio of the total volume of the raw materials of the solid electrolyte material (the organic compound and the sulfide solid electrolyte) to the apparent volume of the solid electrolyte material was calculated as the filling factor by the following formula. The result is shown in Table 1.

$$Filling factor = ( total volume of raw materials of solid electrolyte material \text{} / apparent volume of solid electrolyte material ) \cdot 100$$

TABLE 1

| | | | | Solid |
|---|---|---|---|---|
| | | | Organic | electrolyte |
| | Sulfide | | compound | material |
| | solid | | melting | filling |
| | elec- | | point | factor |
| | trolyte | Organic compound | ° C. | % |
| Comparative | Glass | — | — | 56.59 |
| Example 1 | ceramic | | | |
| Comparative | ↑ | decane | −29.7 | 55.63 |
| Example 2 | | | | |
| Comparative | ↑ | anthracene | 218 | 54.84 |
| Example 3 | | | | |
| Comparative | ↑ | 2,3-dimethylnaphthalene | 105 | 56.39 |
| Example 4 | | | | |
| Example 1 | ↑ | 1,5-dimethylnaphthalene | 82 | 56.78 |
| Example 2 | ↑ | naphthalene | 80.2 | 56.84 |
| Example 3 | ↑ | biphenyl | 69 | 57.04 |
| Example 4 | ↑ | 2-methylnaphthalene | 37 | 57.46 |
| Example 5 | ↑ | 1,4-dimethylnaphthalene | 7.6 | 57.59 |
| Example 6 | ↑ | 1-methylnaphthalene | −22 | 57.80 |
| Comparative | Crystal | — | — | 52.59 |
| Example 5 | | | | |
| Comparative | ↑ | decane | −29.7 | 52.21 |
| Example 6 | | | | |
| Example 7 | ↑ | 1,5-dimethylnaphthalene | 82 | 53.22 |
| Example 8 | ↑ | 1,4-dimethylnaphthalene | 7.6 | 54.09 |
| Example 9 | ↑ | 1-methylnaphthalene | −22 | 54.35 |

FIG. 2 is a graph showing a relationship between the melting point of the organic compound and the filling factor, of each of the solid electrolyte materials respectively obtained in Examples 1 to 9 and Comparative Examples 1 to 6.

A comparison between Examples 1 to 6 and Comparative Examples 1 to 4 that used glass ceramic-based sulfide solid electrolytes shows that Comparative Example 2 that used an organic compound having no benzene ring has a lower filling factor than Comparative Example 1, and that Comparative Examples 2 and 3 that used organic compounds with melting points exceeding 82° C. have lower filling factors than Comparative Example 1, whereas Examples 1 to 6 that used organic compounds having two benzene rings and having melting points not exceeding 82° C. have higher filling factors than Comparative Example 1.

A comparison between Examples 7 to 9 and Comparative Examples 5 and 6 that used crystalline sulfide solid electrolytes shows that Comparative Example 6 that used an organic compound having no benzene ring has a lower filling factor than Comparative Example 5, whereas Examples 7 to 9 that used organic compounds having two benzene rings and having melting points not exceeding 82° C. have higher filling factors than Comparative Example 5.

These results indicate that when an organic compound that has two or more benzene rings and has a melting point not exceeding 82° C. is used, the filling factor improves as the function of the organic compound as a lubricant is exhibit.

### Comparative Example 7

### Production of Electrode Composite Material

Mesitylene was fed into a propylene container, and a layered nickel oxide (a layer-type active material including a nickel element) as a positive electrode active material, a glass ceramic-based sulfide solid electrolyte, and a conductive material were fed into the same container to a ratio of 74/23/3 vol %, and the mixture was stirred by an ultrasonic homogenizer to obtain a slurry. This slurry was fed into a petri dish and then heated and dried to remove the mesitylene. Thus, an electrode composite material was obtained.

### Example 10

### Production of Electrode Composite Material

Mesitylene was fed into a propylene container, and 20 mg of 1,5-dimethylnaphthalene as an organic compound was added thereto and dissolved. A layered nickel oxide as a positive electrode active material, a glass ceramic-based sulfide solid electrolyte, and a conductive material were fed into the same container to a ratio of 74/23/3 vol %, and the mixture was stirred by an ultrasonic homogenizer to obtain a slurry. This slurry was fed into a petri dish and then heated and dried to remove the mesitylene. Thus, an electrode composite material was obtained.

### Example 11

An electrode composite material was obtained by the same method as in Example 10 except that the organic compound was changed to 1,4-dimethylnaphthalene.

### Example 12

An electrode composite material was obtained by the same method as in Example 10 except that the organic compound was changed to 1-methylnaphthalene.

### Comparative Example 8

An electrode composite material was obtained by the same method as in Example 10 except that the organic compound was changed to decane.

### Comparative Example 9

An electrode composite material was obtained by the same method as in Example 10 except that the organic compound was changed to anthracene.

### Measurement of Filling Factor of Electrode Layer

100 mg of each of the electrode composite materials respectively obtained in Examples 10 to 12 and Comparative Examples 7 to 9 was fed into a cylinder with a diameter of 11.28 mm. The obtained electrode layer was held by SUS pins from above and below and subjected to pressing at 19.6 MPa, and the volume of the electrode layer after the pressing was used as the apparent volume of the electrode layer. The ratio of the total volume of the raw materials of the electrode layer (the organic compound, the sulfide solid electrolyte, the layered nickel oxide, and the conductive material) to the apparent volume of the electrode layer was calculated as the filling factor by the following formula. The result is shown in Table 2.

$$Filling factor of electrode layer = ( total volume of raw materials before production of electrode layer \text{} / apparent volume electrode layer ) \cdot 100$$

TABLE 2

| | | | Organic | Electrode |
|---|---|---|---|---|
| | | | compound | layer filling |
| | Electrode composite | | melting point | factor |
| | material | Organic compound | ° C. | % |
| Comparative | layered nickel oxide/sulfide | — | — | 65.21 |
| Example 7 | solid electrolyte/conductive | | | |
| | material | | | |
| Comparative | layered nickel oxide/sulfide | decane | −29.7 | 64.80 |
| Example 8 | solid electrolyte/organic | | | |
| | compound/conductive | | | |
| | material | | | |
| Comparative | ↑ | anthracene | 218 | 64.68 |
| Example 9 | | | | |
| Example 10 | ↑ | 1,5-dimethylnaphthalene | 82 | 65.83 |
| Example 11 | ↑ | 1,4-dimethylnaphthalene | 7.6 | 66.11 |
| Example 12 | ↑ | 1-methylnaphthalene | −22 | 66.23 |

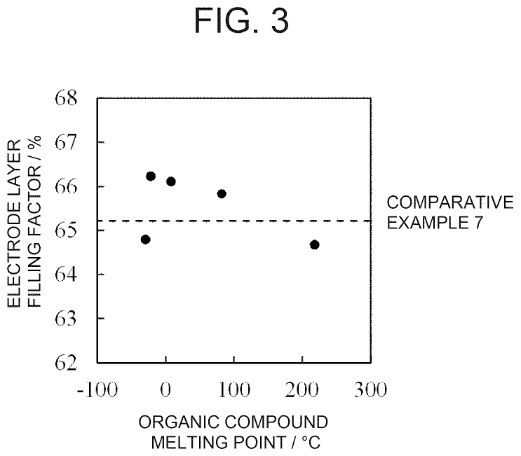

FIG. 3 is a graph showing a relationship between the melting point of the organic compound and the filling factor, of each of the electrode layers respectively obtained in Examples 10 to 12 and Comparative Examples 7 to 9.

Comparative Example 8 that used an organic compound having no benzene ring has a lower filling factor than Comparative Example 7, and Comparative Example 9 that used an organic compound with a melting point exceeding 82° C. has a lower filling factor than Comparative Example 7, whereas Examples 10 to 12 that used organic compounds having two benzene rings and having melting points not exceeding 82° C. have higher filling factors than Comparative Example 7 and therefore can be expected to have an effect of lowering the resistance by reducing the voids in the electrode layer.

What is claimed is:

1. A solid electrolyte material that contains a sulfide solid electrolyte containing a lithium element, a sulfur element, and a phosphorus element, and an organic compound, wherein:
the organic compound has two or more benzene rings; and
a melting point of the organic compound is 82° C. or lower.

2. The solid electrolyte material according to claim 1, wherein the melting point of the organic compound is 37° C. or lower.

3. The solid electrolyte material according to claim 1, wherein the organic compound has two benzene rings.

4. The solid electrolyte material according to claim 1, wherein the organic compound is at least one type selected from a group consisting of naphthalene, 1-methylnaphthalene, 2-methylnaphthalene, 1,4-dimethylnaphthalene, 1,5-dimethylnaphthalene, and biphenyl.

5. A battery comprising a positive electrode layer, a negative electrode layer, and an electrolyte layer, wherein:
the battery includes, in the positive electrode layer or the negative electrode layer, an electrode composite material including the solid electrolyte material according to claim 1 and an electrode active material; and
at least part of the organic compound is present between the electrode active material and the sulfide solid electrolyte.
